(19) United States
(12) Patent Application Publication
(10) Pub. No.: US 2011/0302378 A1
(43) Pub. Date: Dec. 8, 2011

(54) Method for implementation of memory management

(75) Inventor: Fridtjof Siebert, Karlsruhe (DE)

(73) Assignee: aicas GmbH, Karlsruhe (DE)

(21) Appl. No.: 13/134,187

(22) Filed: Jun. 1, 2011

(30) Foreign Application Priority Data
Jun. 2, 2010 (DE) 10 2010 017 215.4

(51) Int. Cl. G06F 12/00

(52) U.S. Cl. 711/155; 711/E12.001

(57) ABSTRACT

A method for implementation of memory management on a read/write memory of a data processing device, in which a multiplicity of tasks (T1-T6) occupy at least parts of the read/write memory, and parts of the read/write memory that were occupied by the tasks (T1-T6) but are no longer needed are found by way of time-based memory cleanup, and released again. The method includes reserving at least one processor of the data processing device for every task (T1-T6), for a duration of at least one time slot, and performing memory cleanup in free time slots reserved for memory cleanup. Work-based memory cleanup is performed by interrupting the tasks (T1-T6) during the time slots reserved for these tasks, before and/or after every memory allocation, for a specific period of time, for the purpose of memory cleanup.

### CROSS REFERENCE TO RELATED APPLICATIONS

Applicant claims priority under 35 U.S.C. 119 of German Application No. 10 2010 017 215.4 filed Jun. 2, 2010.

### BACKGROUND OF THE INVENTION

1. Field of the Invention

The present invention relates to a method for implementation of memory management on a read/write memory of a data processing device, in which a multiplicity of tasks occupy at least parts of the read/write memory, and parts of the read/write memory that were occupied by tasks but are no longer needed are found by way of memory cleanup, and released again. At least one processor of the data processing device is reserved for every task, for the duration of at least one time slot, and memory cleanup takes place in free time slots.

2. The Prior Art

This type of method is described in U.S. Pat. No. 7,624,137 B2. To implement automatic memory management, the object of this patent provides a time-based method, in which automated memory cleanup is carried out in time slots provided for this purpose, in other words at times when a processor is not needed for other applications.

For quite some time already, the original method, that of providing for manual cleanup of the memory during programming of tasks, is being used less and less often, since it is very susceptible to error and can lead not only to malfunctions but also to buffer overflows. Usually, for example in connection with the use of the Java programming language, automatic memory management is carried out, instead, and memory cleanup takes place within the scope of this management, releasing occupied but unused memory again for renewed allocations.

The state of the art knows a number of methods for this. In this connection, a first, simplest method provides for interrupting the progress of all currently running tasks at the moment a memory cleanup is required, in order to carry out the memory cleanup. However, this so-called “stop-the-world” method has the obvious disadvantage that a reaction of the system is not possible during the memory cleanup time, so that real-time processes are not compatible with such a method.

The time-based method mentioned above represents an improvement in that the processor carries out a memory cleanup at the times when it is not being utilized by a running task, with the effect that the tasks can continue to run at the planned times, and have access to the processor. No delay of the tasks takes place on the basis of this interim planning of the memory cleanup.

However, such a method becomes problematic at the moment when the memory demands of the tasks on the various processors become so great that it can no longer be assured that the time slots provided for memory cleanup are sufficient. If more memory is occupied by the tasks than is made available again by way of memory cleanup, the memory will no longer be sufficient after a certain running time, and the system will have to be stopped in order to carry out memory cleanup.

As a reaction to this, it is necessary, in the case of time-based memory management, to carefully weigh the planning of the tasks and of the memory cleanup, in order to ensure that sufficient memory cleanup work is performed to satisfy the demands of the tasks for new memory. Such an alignment of the system is very complicated and requires extremely precise knowledge about the tasks that are running, in each instance, and their memory requirements.

This leads, practically directly, to another memory management method known in the state of the art, namely the work-based method, which has some advantages as compared with the time-based method. In the work-based method, some memory cleanup work is taken care of after every memory allocation, in return, so that in the case of frequent allocations, a lot of memory is released again, while in the case of fewer allocations that occur, and the lower level of occupation that accompanies that, consequently less time is also made available for memory cleanup.

However, because of the fact that the memory cleanup is inserted during the running times of the tasks, the individual tasks run more slowly, while at the same time, empty times that might have been planned in between the tasks elapse without being used.

The conventional methods of the state of the art therefore possess several disadvantages that the invention is trying to circumvent. An overview of the various memory cleanup methods can be found in the literature, for example in Richard Jones and Raphael Lins: “Garbage Collection, Algorithms for Automatic Dynamic Memory Management,” John Wiley & Sons publishing company, 1996.

A first step in the direction of an adaptation to real-time needs is represented by the U.S. Pat. No. 6,349,314 B1, which undertakes a weighing between the need for memory cleanup as compared with the effects of memory cleanup on the process sequence expected by the user and its speed. Depending on the effect that is viewed as being more serious, memory cleanup is carried out or postponed to a later point in time. Because of the complicated index compilation and the weighing that must take place, this method must be viewed as requiring great effort.

However, all the aforementioned methods of the state of the art do not solve the problem of optimally utilizing the system speed with regard to real-time capabilities, and, at the same time, of creating a management, in simple manner, that keeps sufficient memory resources available for the accessing tasks.

### SUMMARY OF THE INVENTION

Against this background, the present invention provides a method for implementation of memory management on a read/write memory of a data processing device, which management fulfills the requirements for real-time tasks, avoids delays in their implementation, and, at the same time, allows simple, clear planning.

This task is accomplished by a method for implementation of memory management on a read/write memory of a data processing device, in which a multiplicity of tasks occupy at least parts of the read/write memory, and parts of the read/write memory that were occupied by tasks but are no longer needed are found by way of time-based memory cleanup, and released again. At least one processor of the data processing device is reserved for every task, for the duration of at least one time slot, and memory cleanup takes place in free time slots reserved for this purpose. In addition, work-based memory cleanup is implemented, in that tasks are interrupted during the time slots reserved for them, before and/or after every memory allocation, for a specific period of time, for the purpose of memory cleanup.

According to the invention, memory management that utilizes the free processor times for memory cleanup, in the sense of a time-based method, is provided. This means that time slots not used by the tasks are reserved and used for memory cleanup, so that no slow-down of the sequence of tasks takes place, since only those times at which the processor would not have been in use otherwise are used for memory cleanup. In addition, however, running tasks can also be interrupted for memory cleanup work, and work-based memory management can be added, at least for individual tasks.

In the end result, the method according to the invention connects the advantages of the time-based method and the work-based method, to produce a combined method that can be configured for the individual tasks, without more detailed information and without precise adaptation.

In a first approach, the memory cleanup can be carried out directly by the tasks that are being interrupted. Such an interruption will preferably take place on a regular basis, in the case of the tasks that work on a work-based basis. For example, it is practical if this takes place before and/or after every memory allocation by a task. Each time a part of the memory is allocated, some memory is cleaned up in a temporal connection with this, preferably to such an extent that this memory cleanup is sufficient, in the final analysis, to meet all the memory requirements.

As an alternative to the possibility of having the memory cleanup be performed only by the tasks themselves, at least one dedicated memory cleanup task can also be used, which handles all the memory cleanup work or supports the tasks in memory cleanup.

Furthermore, time slots can be reserved for such a memory cleanup task, which can be planned like a conventional task, and this can preferably take place at regular or also irregular intervals.

Therefore, it is not necessary to have all the tasks perform memory cleanup work in the work-based method. Furthermore, this is also not practical, since certain time-critical tasks should ideally run without any delay. In this regard, it appears practical to assign priority to the tasks, so that only tasks having a lower priority work in the work-based method. This can take place by establishing a highest priority up to which each of the tasks are assigned to perform work-based, additional memory cleanup. The tasks above this priority threshold, in contrast, continue to be conducted with the uninterrupted, time-based method.

In practice, the configuration of setting the priority of a possible dedicated memory cleanup task at such a level that all the tasks having a lower priority perform additional memory cleanup work, while the tasks having a higher priority are more time-critical and thus are continued with the time-based method, has proven to be practical. At least one memory cleanup task therefore represents the transition threshold from the time-based method to the work-based method in this configuration, with regard to the priority of the tasks.

Details regarding the question to what extent memory cleanup work is required in the work-based method have already been published in connection with the known work-based method, for example in Henry G. Baker, Junior: “List Processing in Real Time on a Serial Computer,” Communications of the ACM 21/4 (April 1978), pages 280-294, or in Fridtjof Siebert: “Guaranteeing Non-disruptiveness and Real-time Deadlines in an Incremental Garbage Collector,” International Symposium on Memory Management, SIGPLAN Notices Volume 34, Issue 3 (March 1999).

An essential criterion for the question as to what tasks perform additional work-based memory cleanup at what point in time is the question whether more memory is allocated, over a specific time period, than can be made available again to the task by means of memory cleanup. To the extent that this was the case, the memory would necessarily run out at some point, and therefore all the tasks would be suspended, according to the known “stop-the-world” method, until sufficient memory cleanup has taken place.

By monitoring the memory requirements and the amount of time-based memory cleanup work over a specific time period, it can be determined whether or not the memory cleanup work currently being performed is sufficient. As a reaction to this, it is provided, according to the method, to shift the priority limit further upward, so that more tasks perform additional memory cleanup.

Optionally, if the amount of time-based memory cleanup work is sufficient, it is possible to do without additional work-based memory cleanup entirely, at least part of the time.

The work-based additional memory cleanup work can be reduced again or terminated completely as soon as sufficient memory is available again, or as soon as it can be determined that then the memory cleanup carried out only using the time-based method, if applicable, is sufficient.

To determine at what point in time a transition for the tasks provided for this purpose, to work-based memory cleanup work, exists, it is regularly or irregularly checked, using means for memory monitoring, whether more memory is occupied by the tasks than can be made available again by the memory cleanup. This can be done in that a reservation segment is defined in the memory that is available for allocation, on which segment memory allocation work and exclusively time-based memory cleanup work take place, at least within a certain time period. If this memory is completely filled over a specific time period, it can be deduced from this that the memory cleanup work, in contrast to the memory allocation work, is not sufficient, and that therefore additional work-based memory cleanup must be supported.

Such a reservation segment can have a variable size, but does not exceed a maximal size that should preferably be selected in such a manner that the maximal size of the reservation segment plus the size of the allocated memory is less than the total memory available. If the limit of capacity is reached with such a maximal reservation segment size, a limited amount of memory is then still available to continue the system until the work-based memory cleanup that has been switched in takes hold as a measure, and more memory was made available again.

If the data processing device used has more than one processor, each processor in itself can have tasks assigned to it. Each time slot can be assigned to a task once for each processor, whereby in the case of multi-processor systems, there is even the possibility of making entire processors available solely for memory cleanup work.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a memory cleanup method according to the stop-the-world approach, according to the state of the art, in a scheduling diagram;

FIG. 2 shows a memory cleanup method according to the work-based approach, according to the state of the art, in a scheduling diagram;

FIG. 3 shows a memory cleanup method according to the time-based approach, according to the state of the art, in a scheduling diagram;

FIG. 4 shows a memory cleanup method in which only tasks with a low priority are working in the work-based method; and

FIG. 5 shows a memory cleanup method in which even tasks with a higher priority are working in the work-based method.

### DETAILED DESCRIPTION OF THE PREFERRED EMBODIMENT

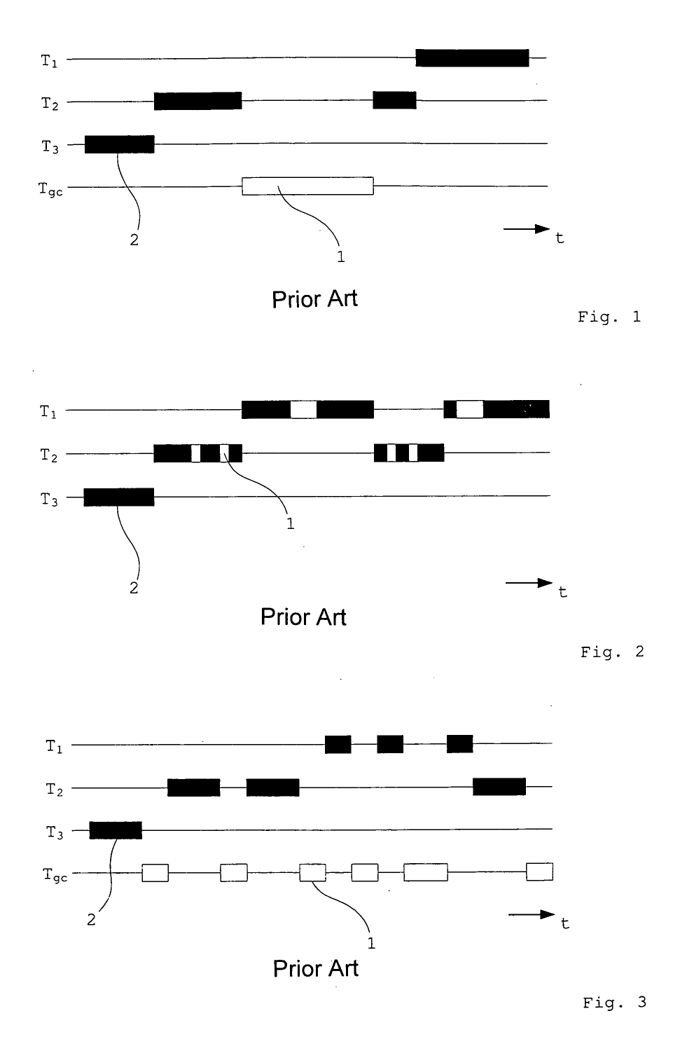

Referring now in detail to the drawings, FIG. 1 shows a scheduling diagram in which a total of three tasks T1-T3 are running. First, task T3 is running, whereupon it is pre-empted by task T2. In the course of the implementation of task T2, the system determines that no memory is available any longer for further implementation of task T2, and the system is stopped to call up a memory cleanup task Tgc (gc for garbage collection), which makes allocated but no longer needed memory available again. This method is called “stop-the-world” method, according to the effect that such a method of procedure triggers. During the memory cleanup time, which became necessary right in the middle of implementation of task T2, the system cannot work any longer, due to lack of memory, so that for the time being it is necessary to make memory available again and thereby to ensure further implementation of tasks T1-T3. After completion of the memory cleanup 1, the task implementation 2 is continued.

An improvement as compared with this method according to the state of the art is represented by another method according to the state of the art, namely the so-called work-based method, as shown in FIG. 2. In this method, memory cleanup 1 is carried out within each task implementation 2, after a memory allocation process, for equalization, so that in the end result, just as much memory is released again as is occupied by tasks T1-T3. In this manner, it is ensured that memory is always available to a sufficient extent. A disadvantage of this method of the state of the art is the regular interruption of tasks T1-T3, which must therefore run more slowly.

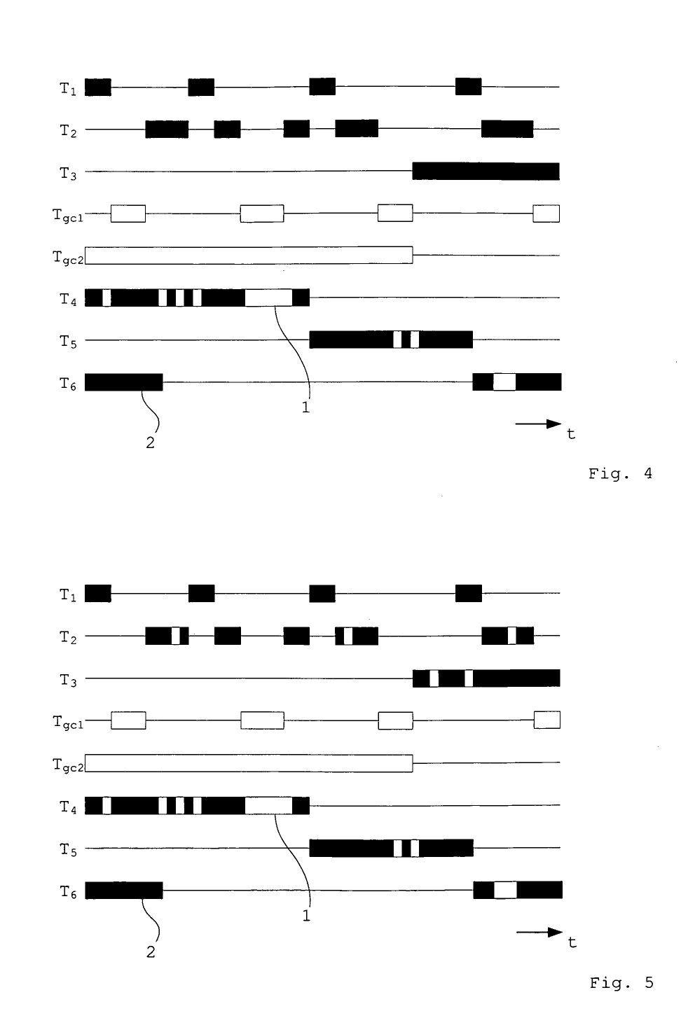

As an alternative to the work-based method according to FIG. 2 as mentioned above, in FIG. 3 the so-called time-based method is shown, which is also known in the state of the art. In the time-based method, time intervals between the implementation of individual tasks T1-T3 are used in order to allow a memory cleaning task Tgc to run during these interim times when the processor is not needed. This memory cleanup task Tgc will now release the occupied but no longer needed memory for renewed allocation to the tasks. A disadvantage of this method is that the use of the memory cleanup task Tgc must be very carefully adapted to the needs of the tasks T1-T3, so that sufficient memory cleanup 1 is carried out to bring about task implementation 2 without interruption and without memory bottlenecks.

FIG. 4 represents an exemplary embodiment of the method according to the invention, which combines the advantages of the time-based method and of the work-based method in itself. Six tasks T1-T6 are shown, along with two memory cleanup tasks Tgc1, Tgc2. Tasks T1-T6, Tgc1, Tgc2 are organized according to priority, from top to bottom. The three tasks T1-T3 having the highest priority are called up purely according to the aspects of the time-based method, in other words they are not interrupted for memory cleanup. Instead, only the interim times between different call-ups of the tasks T1-T3 are used to perform memory cleanup 1 during these times. In the system shown in FIG. 4, at least four processors are used, and tasks T1-T6, Tgc1, Tgc2 are distributed among these processors.

Tasks T4-T6 are situated below the priority of memory cleanup tasks Tgc1, Tgc2, whereby the system is designed in such a manner that these low-priority tasks T4-T6 are operated using a work-based method. This means that tasks T4-T6 are interrupted for a while after every memory allocation process, in order to themselves perform a memory cleanup 1 and thereby support memory cleanup tasks Tgc1, Tgc2.

FIG. 5 shows the same scheduling as shown in the method according to FIG. 4, whereby now, the priority limit for additional memory cleanup work has been shifted upward. This has the reason that in this case, the work performed by the time-based memory cleanup 1 in memory cleanup tasks Tgc1, Tgc2 is not sufficient, and this is supposed to be corrected by additional memory cleanup work. Such additional memory cleanup 1 is planned in during task implementation 2 of tasks T2, T3, which now lie below the newly set priority threshold. By adding the memory cleanup times in the tasks T2, T3, it is ensured that more memory will be made available for allocation to tasks T1-T6, in real time.

Thus, a method for implementation of memory management on a read/write memory of a data processing device is described, in which the known time-based and work-based methods are combined to produce a new type of method that makes use of the advantages of both methods.

Accordingly, while only a few embodiments of the present invention have been shown and described, it is obvious that many changes and modifications may be made thereunto without departing from the spirit and scope of the invention.

### REFERENCE SYMBOL LIST

T1-T6 tasks
Tgc1-Tgc2 memory cleanup tasks
1 memory cleanup
2 task implementation
t time

What is claimed is:

1. A method for implementation of memory management on a read/write memory of a data processing device, in which a multiplicity of tasks (T1-T6) occupy at least parts of the read/write memory, and parts of the read/write memory that were occupied by the tasks (T1-T6) but are no longer needed are found by way of time-based memory cleanup, and released again, comprising the following steps:
reserving at least one processor of the data processing device for every task (T1-T6), for a duration of at least one time slot;
performing memory cleanup in free time slots reserved for memory cleanup; and
performing work-based memory cleanup by interrupting said tasks (T1-T6) during the time slots reserved for said tasks, before and/or after every memory allocation, for a specific period of time, for the purpose of memory cleanup.

2. The method according to claim 1, wherein the memory cleanup is carried out by the tasks (T1-T6) themselves.

3. The method according to claim 1, wherein at least one dedicated memory cleanup task (Tgc1, Tgc2) is used, by means of which the memory cleanup is carried out exclusively or additionally.

4. The method according to claim 3, wherein time slots are reserved for the memory cleanup task (Tgc1, Tgc2), at regular or irregular intervals.

5. The method according to claim 3, wherein each task (T1-T6) has a priority assigned to it, and wherein interruptions for work-based memory cleanup take place only in the case of tasks (T1-T6) below a specific priority level.

6. The method according to claim 5, wherein a priority is assigned to the memory cleanup task (Tgc1, Tgc2), and wherein interruptions for work-based memory cleanup take place only in the case of tasks (T1-T6) below the priority level of the memory cleanup tasks (Tgc1, Tgc2).

7. The method according to claim 6, wherein the priority level below which tasks (T1-T6) can be interrupted for memory cleanup can be changed as a function of the available memory.

8. The method according to claim 6, wherein interruptions of tasks (T1-T6) for work-based memory cleanup or raising of the priority level below which tasks can be interrupted for work-based memory cleanup take place only if in a time segment being considered, so much memory is occupied that time-based memory cleanup is insufficient to release enough memory.

9. The method according to claim 8, further comprising the step of checking, at regular or irregular intervals, using means for memory monitoring, whether so much memory is being allocated that the time-based memory cleanup is insufficient to release enough memory, and a reservation segment of the read/write memory is reserved and all allocation and memory cleanup work is carried out on this reservation segment, wherein the determination that the time-based memory cleanup is insufficient is made when a limit value of memory allocation is exceeded in the reservation segment.

10. The method according to claim 9, wherein the reservation segment is of variable size, but cannot exceed a maximal size.

11. The method according to claim 10, wherein the sum of the maximal size of the reservation segment and the size of the allocated memory is less than the total available read/write memory.

12. The method according to claim 10, wherein when the value for memory allocation drops below a lower limit value, in the reservation segment, interruptions of tasks (T1-T6) no longer take place for work-based memory cleanup, during the time slots reserved for them.

13. The method according to claim 1, wherein the data processing device has a plurality of processors, and wherein every time slot can be assigned to a task (T1-T6, Tgc1, Tgc2) once for every processor.
